(19) United States
(12) Patent Application Publication
(10) Pub. No.: US 2008/0241595 A1
(43) Pub. Date: Oct. 2, 2008

(54) Magnetic recording medium

(75) Inventors: Kaori Kimura, Tokyo (JP); Yoshiyuki Kamata, Tokyo (JP); Satoshi Shirotori, Yokohama-shi (JP); Shinobu Sugimura, Yokohama-shi (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 12/076,949

(22) Filed: Mar. 25, 2008

(30) Foreign Application Priority Data
Mar. 26, 2007 (JP) 2007-080133

(51) Int. Cl. G11B 5/62; C23F 1/00

(52) U.S. Cl. 428/800; 216/22

(57) ABSTRACT

A magnetic recording medium includes a soft magnetic underlayer formed on a substrate, magnetic patterns made of a ferromagnetic material and provided separately on the soft magnetic underlayer, and a nonmagnetic layer including two sublayers or more of a same material and formed on the soft magnetic underlayer between the magnetic patterns.

### CROSS-REFERENCE TO RELATED APPLICATIONS

This application is based upon and claims the benefit of priority from prior Japanese Patent Application No. 2007-080133, filed Mar. 26, 2007, the entire contents of which are incorporated herein by reference.

### BACKGROUND OF THE INVENTION

1. Field of the Invention

The present invention relates to a magnetic recording medium capable of recording at high density.

2. Description of the Related Art

In the modern information society, the amount of data, which is recorded on a recording medium, has been continually increasing. To keep up with the increase in amount of data, there has been a demand for a recording medium and a recording apparatus with a dramatically increased recording capacity. As regards hard disks for which there is an increasing demand as high-capacity, inexpensive magnetic recording media, it is said that a recording density of 1 terabits per square inch or more, which is about ten times higher than a current recording density, will be required several years after.

In an existing magnetic recording medium used in a hard disk, one bit is recorded in a specific region of a thin film made of polycrystals of fine magnetic grains. To raise the recording capacity of the magnetic recording medium, therefore, the recording density must be increased. For this purpose, it is effective to reduce the recording mark size usable in recording per bit. If, however, the recording mark size is merely reduced, effects of recording noise caused by the shape of fine magnetic grains cannot be ignored. Instead, if the fine magnetic grains are further reduced in size, problems of thermal fluctuation occur, and it is impossible to maintain the information recorded in fine magnetic grains at an ordinary temperature.

To avoid these problems, in the field of magnetic recording, it is proposed to used a patterned media in which recording dots are separated by a non-recording material in advance, for performing read and write using a single recording dot as one recording cell.

Concerning the recent enhancement of track density of HDD, a problem of interference between adjacent tracks becomes apparent. In particular, reduction of fringing effect of a recording head field is an important technical problem. A discrete track recording (DTR) medium in which recording tracks are separated physically is expected to provide a high-density magnetic recording medium because side erase in write operation and side read in read operation can be reduced and hence the density in the cross-track direction can be enhanced. The DTR medium is also one type of a patterned media, and hence, the patterned media is supposed herein to include the DTR medium.

To assure stable flying of the head in the DTR medium or patterned media in which recording tracks or recording cells are separated physically, it is important to fill the recesses between magnetic patterns with a nonmagnetic layer. However, such nonmagnetic material used in filling is generally very hard. Therefore, during performing read or write of the medium assembled in the drive, if the filled nonmagnetic layer contacts the head, the nonmagnetic layer may be cracked.

### BRIEF SUMMARY OF THE INVENTION

According to an aspect of the present invention, there is provided a magnetic recording medium comprising: a soft magnetic underlayer formed on a substrate; magnetic patterns made of a ferromagnetic material and provided separately on the soft magnetic underlayer; and a nonmagnetic layer comprising two sublayers or more of a same material and formed on the soft magnetic underlayer between the magnetic patterns.

According to another aspect of the present invention, there is provided a method of manufacturing a magnetic recording medium comprising: depositing a soft magnetic underlayer on a substrate; providing magnetic patterns made of a protruded ferromagnetic material separately from each other on the soft magnetic underlayer; and repeating procedures of depositing a nonmagnetic material on an entire surface and etching-back the nonmagnetic material twice or more to form a nonmagnetic layer comprising two sublayers or more of a same material on the soft magnetic underlayer between the magnetic patterns.

According to still another aspect of the present invention, there is provided a method of manufacturing a magnetic recording medium comprising: depositing a soft magnetic underlayer on a substrate; depositing a ferromagnetic layer on the soft magnetic underlayer; applying a resist to the ferromagnetic layer; arranging a stamper having protruded patterns so as to face the resist; imprinting the stamper on the resist to transfer the protruded patterns of the stamper to the resist; removing resist residues remaining at bottoms of recesses of the resist; etching the ferromagnetic layer using the protruded patterns of the resist as masks to form magnetic patterns separately from each other on the soft magnetic underlayer; and repeating procedures of depositing a nonmagnetic material on a surface of the magnetic patterns and on a surface of the soft magnetic underlayer and etching-back the nonmagnetic material twice or more to form a multilayered nonmagnetic layer in the recesses between the magnetic patterns.

### BRIEF DESCRIPTION OF THE SEVERAL VIEWS OF THE DRAWING

FIG. 1 is a plan view of a discrete track recording medium;

FIG. 2 is a plan view of a patterned media;

FIG. 3 is a cross-sectional view of a magnetic recording medium according to a first embodiment;

FIG. 4 is a cross-sectional view of a magnetic recording medium according to a modified first embodiment;

FIG. 5 is a cross-sectional view of a magnetic recording medium according to a second embodiment; and

FIGS. 6A, 6B, 6C, 6D, 6E, 6F and 6G are cross-sectional views showing a method of manufacturing a magnetic recording medium according to an embodiment.

### DETAILED DESCRIPTION OF THE INVENTION

Embodiments of the invention will be described below with reference to the accompanying drawings.

FIG. 1 is a plan view in the circumferential direction of a discrete track medium. As shown in FIG. 1, a servo region 10 and a data region 20 are formed alternately in the circumferential direction of the medium. The servo region 10 includes a preamble part 11, an address part 12, and a burst part 13. The data region 20 includes recording tracks 21.

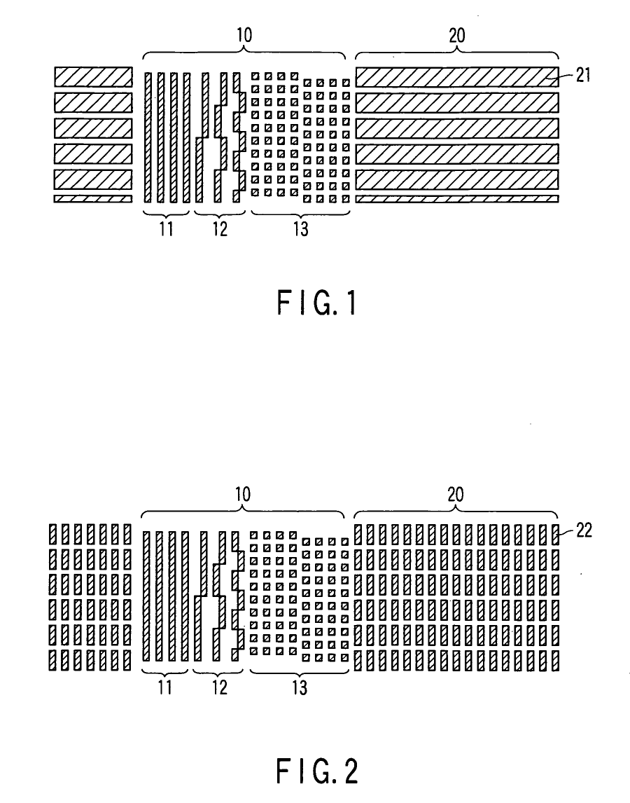

FIG. 2 is a plan view in the circumferential direction of a patterned media. In the data region 20 in FIG. 2, magnetic dots 22 are formed by physically separating a ferromagnetic layer both in the cross-track direction and in the down-track direction.

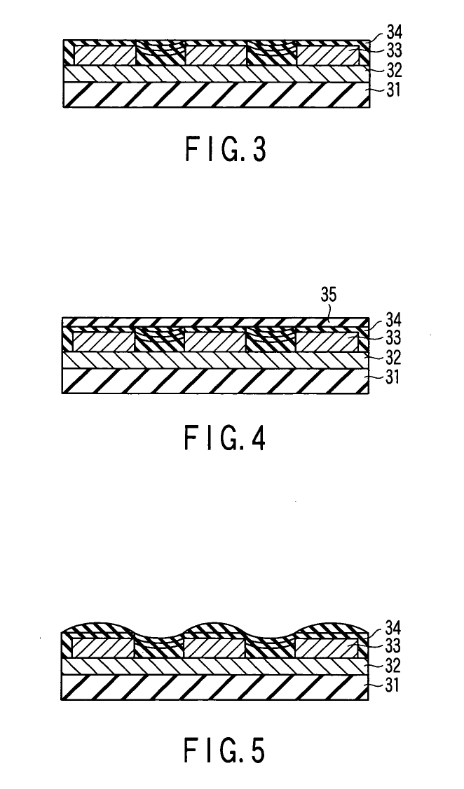

FIG. 3 is a cross-sectional view of a magnetic recording medium according to a first embodiment of the invention. This shows a cross-sectional view of the data region. A soft magnetic underlayer 32 is formed on a nonmagnetic substrate 31. On the soft magnetic underlayer 32, protruded ferromagnetic layers 33 patterned in discrete tracks or magnetic dots are formed in a state separated from each other. Nonmagnetic layers 34 are filled in the recesses between the patterned ferromagnetic layers 33. The nonmagnetic layer 34 has a multilayered structure comprising two sublayers or more made of the same material. The reason why the nonmagnetic layer is expresses as the “multilayered structure” in spite of the same material is that deviation in density or composition occurs within recesses in the film thickness direction. Such deviation in density or composition in the film thickness direction of the nonmagnetic layer 34 can be observed with sectional TEM, for example, as a thin layer different in color sandwiched between two sublayers.

The nonmagnetic material hitherto used to fill the recesses has high hardness. Therefore, if a read/write head contacts the nonmagnetic material of a medium in a hard disk drive, the nonmagnetic layer 34 is likely to be cracked and also a head crash may be caused. In the magnetic recording medium of the embodiment, the multilayered nonmagnetic layer 34 has softness in structure and can absorb impact. Accordingly, even if the head contacts the nonmagnetic material, the nonmagnetic layer 34 is not likely to be cracked. The number of sublayers of the multilayered nonmagnetic layer 34 is preferred to be at least two from the viewpoint of absorption of impact. As the number of sublayers is increased, the degree of absorption of impact is increased. However, from the viewpoint of process time, the number of sublayers should not exceed ten and is preferably eight or less.

As shown in FIG. 3, the nonmagnetic layer 34 used to fill the recess may also be used as a protective layer of the ferromagnetic layer 33.

As shown in a modified first embodiment in FIG. 4, a protective layer 35 may be further formed on the ferromagnetic layer 33. This is because, when the nonmagnetic layer 34 is flattened, the surface of the ferromagnetic layer 33 may be exposed, in which case it is preferred to form the protective layer 35.

FIG. 5 is a cross-sectional view of a magnetic recording medium according to a second embodiment of the invention. A soft magnetic underlayer 32 is formed on a nonmagnetic substrate 31. On the soft magnetic underlayer 32, protruded ferromagnetic layers 33 patterned in discrete tracks or magnetic dots are formed in a state separated from each other. Nonmagnetic layers 34 are filled in the recesses between the patterned ferromagnetic layers 33. The nonmagnetic layer 34 has a multilayer structure of two layers or more formed of the same material. In this embodiment, since the nonmagnetic layer 34 is not flattened sufficiently, there is a height difference Δd between the upper surface of the nonmagnetic layer 34 filled in the recesses and the upper surface of the nonmagnetic layer 34 on the ferromagnetic layer 33. In a case where there is a certain height difference Δd on the surface, takeoff characteristics from a touchdown state of the read/write head on the medium are improved. The height difference Δd is preferred to be 10 nm or less from the viewpoint of flying stability.

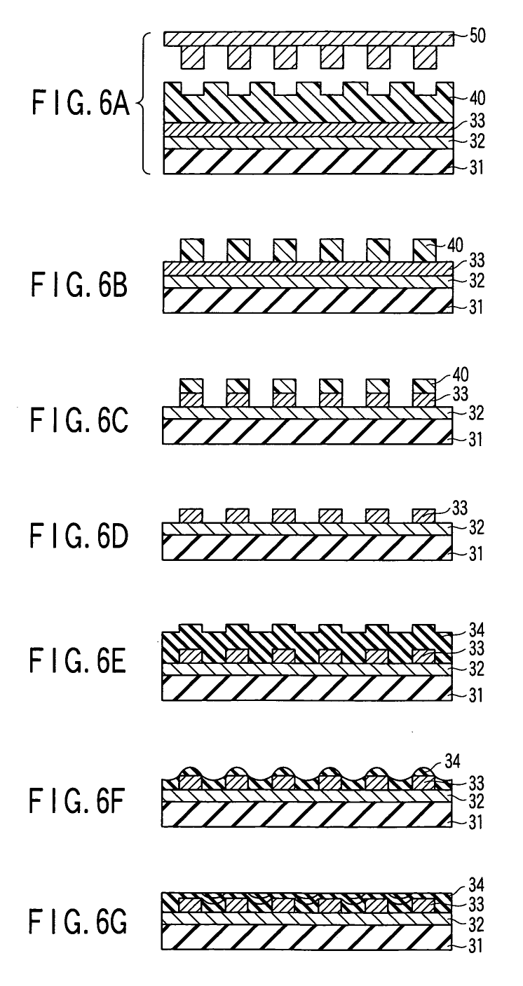

Referring now to FIGS. 6A, 6B, 6C, 6D, 6E, 6F and 6G, a method of manufacturing a magnetic recording medium according to an embodiment of the invention will be described.

As shown in FIG. 6A, the soft magnetic underlayer 32 and ferromagnetic layer 33 are formed on the nonmagnetic substrate 31. In this stage, a carbon protective layer may be formed on the ferromagnetic layer 33. A resist 40 is formed on the surface of the medium by spin-coating. The resist may be a common novolak photoresist or spin-on-glass (SOG). Further, a stamper 50 having patterns of recording tracks and servo data corresponding to the patterns shown in FIG. 1 or 2 is provided. Then, imprinting is performed in the following manner. The substrate 31 and stamper 50 are placed on the lower plate of a die set, the protruded surface of the stamper 50 is faced oppositely to the resist 40 on the substrate 31, on which stamper 50 the upper plate of the die set is placed. By pressing for 60 seconds at 2000 bar, the patterns of the stamper 50 are transferred to the resist 40.

Here, if the initial thickness of the resist is about 130 nm, the height of the protruded portion of the pattern formed by imprinting is 60 to 70 nm, and the thickness of the resist residue remaining in the bottom of the recesses is about 70 nm. The pressing duration of 60 seconds corresponds to the time sufficient for moving the resist to be eliminated. By applying a fluorine-based release agent or depositing a film of diamond-like carbon (DLC) containing fluorine on the stamper 50, the stamper and resist can be separated from each other favorably.

As shown in FIG. 6B, when a common photoresist is used as the resist 40, the resist residues in the recesses are removed by oxygen reactive ion etching (RIE) by which the ferromagnetic layer 33 is exposed. When SOG is used in the resist 40, the resist residues are removed by CF₄ gas. The plasma source is preferably inductively coupled plasma (ICP) capable of generating high-density plasma at low pressure, but an electron cyclotron resonance (ECR) plasma apparatus or a general parallel plate RIE apparatus may be used.

As shown in FIG. 6C, the ferromagnetic layer 33 is processed by using the resist pattern as an etching mask. For processing the ferromagnetic layer 33, Ar ion beam etching (Ar ion milling) is preferred, but RIE using Cl gas, CO—NH₃ mixed gas or methanol may also be applied. In the case of RIE using CO—NH₃ mixed gas, a hard mask such as Ti, Ta or W is used as the etching mask. When processed by RIE, the sidewalls of the protruded pattern of the ferromagnetic layer are not tapered. In the case of processing the ferromagnetic layer by Ar ion milling capable of etching any material, the acceleration voltage is set at 400 V, for example, and the ion incidence angle is varied from 30 to 700. In the case of milling using an ECR ion gun, the sidewalls of the protruded pattern of the ferromagnetic layer are hardly tapered by performing etching under static opposite state, where the ion incidence angle is set at 90°.

As shown in FIG. 6D, the resist is removed. When a common photoresist is used as the resist, it can be easily removed by oxygen plasma etching. At this time, when a carbon protective layer is formed on the surface of the ferromagnetic layer 33, the carbon protective layer is also removed. When SOG is used as the resist, it can be removed by RIE using fluorine-containing gas. CF₄ or SF₆ is preferably used as the fluorine-containing gas. However, the substrate should be washed with water after removal of the resist because acid such as HF or H₂SO₄ may be produced of CF₄ or SF₆ by reaction with moisture in the atmosphere.

As shown in FIG. 6E, the nonmagnetic layer 34 is deposited on the entire surface to be filled in the recesses. Examples of the nonmagnetic material include C, Si, SiO₂, SiₓN_{y}, SiON, SiC, SiOC, TiOx, Al₂O₃, Ru, Ta, and NiTa. Such a nonmagnetic material is deposited by bias sputtering or ordinary sputtering. The bias sputtering is a method of sputter-depositing a film while applying a bias to the substrate, making it possible to fill the recesses easily. However, since melting of the substrate or sputtering dust is likely to occur due to the substrate bias, the ordinary sputtering is preferred.

As shown in FIG. 6F, the nonmagnetic layer 34 is etched back. Etching-back is stopped immediately before the ferromagnetic layer 33 is exposed. In the etching-back process, it is preferred to apply etching under perpendicular incidence using an ECR ion gun. When a silicon-based filling agent such as SiO₂ is used, RIE using fluorine-containing gas may also be applied. Ar ion milling is also applicable.

As shown in FIG. 6G, deposition and etching-back of the same nonmagnetic material are repeated at least twice, whereby the multilayered nonmagnetic layer 34 is formed in the recesses between the patterned ferromagnetic layers 33.

At this time, the nonmagnetic layer 34 may be left on the ferromagnetic layer 33, and it may be used as a protective layer. A carbon protective layer may be formed after etching back. The carbon protective layer is preferably deposited by CVD for improving coverage on the surface, but it may be deposited by sputter-deposition or vacuum evaporation. When the CVD is applied, a diamond-like carbon (DLC) film containing a number of sp³-bonded carbon atoms is formed. In any case, the thickness of the protective layer on the ferromagnetic layer is preferred to be 1 to 10 nm. If the thickness is less than 1 nm, the coverage is made poor. If the thickness exceeds 10 nm, the magnetic spacing between the read/write head and the medium is increased, leading to lowered signal-to-noise ratio (SNR).

A lubricant may be applied on the protective film. The lubricant may be known materials, such as perfluoropolyether, fluorinated alcohol, or fluorinated carboxylic acid.

Materials used in the embodiment of the invention will be described below.

<Substrate>

The substrate may be a glass substrate, Al-based alloy substrate, ceramic substrate, carbon substrate, or Si single crystal substrate having an oxide surface. The glass substrate may be made of amorphous glass or crystallized glass. Examples of the amorphous glass include general-purpose soda lime glass and aluminosilicate glass. Examples of the crystallized glass include lithium-based crystallized glass. Examples of the ceramic substrate include a sintered body mainly made of general-purpose aluminum oxide, aluminum nitride, or silicon nitride, and fiber-reinforced products thereof. The substrate having a NiP layer on the surface of the metal substrate or nonmetal substrate by plating or sputtering may be used.

The method of depositing a film on the substrate is not limited to sputtering, and vacuum evaporation or electroplating would provide the same effects.

<Soft Magnetic Underlayer>

The soft magnetic underlayer (SUL) serves as a part of the magnetic head by passing the recording magnetic field from a single pole head for magnetizing the perpendicular magnetic recording layer in the horizontal direction and returning it to the magnetic head side, and has an action of enhancing the write efficiency by applying a steep and sufficient perpendicular field to the recording layer. The soft magnetic underlayer may be made of a material containing Fe, Ni, or Co. Examples of such material include FeCo-based alloy such as FeCo and FeCoV, FeNi-based alloy such as FeNi, FeNiMo, FeNiCr and FeNiSi, FeAl-based alloy or FeSi-based alloy such as FeAl, FeAlSi, FeAlSiCr, FeAlSiTiRu and FeAlO, FeTa-based alloy such as FeTa, FeTaC and FeTaN, and FeZr-based alloy such as FeZrN. It is also possible to use a material having a fine crystalline structure such as FeAlO, FeMgO, FeTaN, and FeZrN containing Fe by 60 at % or more, or a granular structure having fine crystal grains dispersed in a matrix. Other materials of the soft magnetic underlayer include Co alloys containing Co and at least one of Zr, Hf, Nb, Ta, Ti, and Y. The Co alloy is preferred to contain Co by 80 at % or more. Such Co alloy is likely to form an amorphous layer when deposited by sputtering. The amorphous soft magnetic material is free from crystalline anisotropy, crystal defects, and grain boundaries, and hence shows a very excellent soft magnetic property, and is capable of lowering medium noise. Examples of a preferred amorphous soft magnetic material include, for example, CoZr-based, CoZrNb-based, and CoZrTa-based alloys.

Another underlayer may further be formed under the soft magnetic underlayer in order to enhance the crystallinity of the soft magnetic underlayer or to enhance adhesion with the substrate. The material of such underlayer may be Ti, Ta, W, Cr, Pt, their alloy, or their oxide or nitride. An intermediate layer of a nonmagnetic material may be provided between the soft magnetic underlayer and the recording layer. The intermediate layer has two functions of interrupting exchange coupling interaction between the soft magnetic underlayer and the recording layer and controlling the crystallinity of the recording layer. The material of the intermediate layer may be Ru, Pt, Pd, W, Ti, Ta, Cr, Si, their alloy, or their oxide or nitride.

To prevent spike noise, the soft magnetic underlayer may be divided into several layers, and Ru with a thickness of 0.5 to 1.5 nm may be inserted therebetween to allow antiferromagnetic coupling. Further, a pinning layer made of a hard magnetic film having in-plane anisotropy such as CoCrPt, SmCo, or FePt or an antiferromagnetic material such as IrMn or PtMn may be exchange-coupled with the soft magnetic underlayer. To control the exchange coupling force, a magnetic film (e.g., Co) or a nonmagnetic film (e.g., Pt) may be stacked above and below the Ru layer.

<Ferromagnetic Layer>

The ferromagnetic layer used as the perpendicular magnetic recording layer is preferably composed of a material contains Co as a main component, and contains at least Pt, and further contains oxide. The perpendicular magnetic recording layer may also contain Cr as required. As the oxide, silicon oxide or titanium oxide is particularly suitable. The perpendicular magnetic recording layer preferably has magnetic grains (crystal grains with magnetic properties) dispersed therein. The magnetic grains are preferred to be in a columnar structure penetrating the perpendicular magnetic recording layer in the thickness direction. Such a structure may improve the orientation and crystallinity of magnetic grains of the perpendicular magnetic recording layer, so that a proper signal-to-noise ratio (SNR) suitable to high-density recording may be provided. To attain such a structure, the amount of the oxide contained in the layer is very important.

The oxide content in the perpendicular magnetic recording layer is preferred to be 3 mol % or more and 12 mol % or less in the total amount of Co, Cr and Pt, more preferably 5 mol % or more and 10 mol % or less. The above range of the oxide content in the perpendicular magnetic recording layer is preferred because the oxide precipitated around the magnetic grains, which separates magnetic grains and reduces their sizes during formation of the perpendicular magnetic recording layer. If the oxide content exceeds the above range, the oxide remains in the magnetic grains, which degrades the orientation and crystallinity of the magnetic grains, and further, excess oxide deposits above and below the magnetic grains. As a result, a columnar structure that magnetic grains penetrate the perpendicular magnetic recording layer in the thickness direction may not be formed. If the oxide content is less than the above range, separation of the magnetic grains and reduction in sizes of the magnetic grains may be made insufficient. As a result, the noise in reading is increased and the signal-to-noise ratio (SNR) suitable to high-density recording is not provided.

The Cr content in the perpendicular magnetic recording layer is preferably 0 at % or more and 16 at % or less, more preferably 10 at % or more and 14 at % or less. The above range of the Cr content is preferred because the uniaxial crystalline anisotropy constant Ku of magnetic grains is not lowered too much, and high magnetization is maintained, so that read/write characteristics suited to high-density recording and sufficient thermal fluctuation resistance may be provided. If the Cr content exceeds the above range, Ku of magnetic grains decreases, resulting in poor thermal fluctuation characteristics. Also, higher Cr content brings about poor crystallinity and orientation of magnetic grains, so that the read/write characteristics are degraded.

The Pt content in the perpendicular magnetic recording layer is preferably 10 at % or more and 25 at % or less. The above range of the Pt content is preferred because Ku necessary for the perpendicular magnetic recording layer can be provided and the crystallinity and orientation of magnetic grains are improved, so that the thermal fluctuation characteristics and read/write characteristics suited to high-density recording may be provided. If the Pt content exceeds the above range, a layer of fcc structure is formed in the magnetic grains, and the crystallinity and orientation may be made poor. If the Pt content is less than the above range, sufficient Ku for thermal fluctuation resistance suited to high-density recording is not provided.

The perpendicular magnetic recording layer may contain, in addition to Co, Cr, Pt and oxide, at least one element selected from the group consisting of B, Ta, Mo, Cu, Nd, W, Nb, Sm, Tb, Ru, and Re. Such element serves to enhance reduction in size of magnetic grains and to improve the crystallinity and orientation of magnetic grains, making it possible to provide read/write characteristics and thermal fluctuation characteristics more suited to high-density recording. The total content of the above elements is preferred to be 8 at % or less. If the content exceeds 8 at %, a phase other than hcp phase is formed in magnetic grains, which disturbs the crystallinity and orientation of magnetic grains, so that read/write characteristics and thermal fluctuation characteristics suited to high-density recording are not provided.

Examples of the perpendicular magnetic recording layer include CoPt-based alloy, CoCr-based alloy, CoPtCr-based alloy, CoPtO, CoPtCrO, CoPtSi, CoPtCrSi, or a multilayer structure of Co with alloy mainly composed of at least one element selected from the group consisting of Pt, Pd, Rh, and Ru, or their alloy added with Cr, B and O, such as CoCr/PtCr, CoB/PdB, and CoO/RhO.

The thickness of the perpendicular magnetic recording layer is preferably 5 to 60 nm, more preferably 10 to 40 nm. In this range, a magnetic recording apparatus more suited to high-density recording may be manufactured. If the thickness of the perpendicular magnetic recording layer is less than 5 nm, the read output is too low and the noise component is likely to be higher. If the thickness of the perpendicular magnetic recording layer exceeds 40 nm, the read output becomes too high, which may deform the waveform. The coercivity of the perpendicular magnetic recording layer is preferably 237,000 A/m (30000e) or more. If the coercivity is less than 237,000 A/m (30000e), the thermal fluctuation resistance may be made poor. The perpendicular squareness of the perpendicular magnetic recording layer is preferably 0.8 or less. If the perpendicular squareness is less than 0.8, the thermal fluctuation resistance may be made poor.

<Protective Layer>

The protective layer is provided for preventing corrosion of the perpendicular magnetic recording layer, and for preventing damage of the medium surface when the magnetic head contacts the medium. The material of the protective layer includes, for example, C, SiO₂ and ZrO₂. The thickness of the protective layer is preferably 1 to 10 nm. The protective layer in this range makes the distance between the head and the medium small, which is preferable for high-density recording. Carbon may be classified into sp²-bonded carbon (graphite) and sp³-bonded carbon (diamond). The sp³-bonded carbon is superior in durability and corrosion resistance, but it is inferior to graphite in surface smoothness since it is crystalline. A carbon film is generally deposited by sputtering using a graphite target. In this method, amorphous carbon, in which sp²-bonded carbon and sp³-bonded carbon are mixed, is formed. The carbon higher in the ratio of sp³-bonded carbon is called diamond-like carbon (DLC), which is excellent in durability and corrosion resistance, and is also excellent in surface smoothness because it is amorphous. Therefore, it is utilized as a surface protective layer of a magnetic recording medium. Chemical vapor deposition (CVD), which excites and decomposes source gases in plasma and produces DLC through chemical reaction, makes it possible to deposit DLC rich in sp³-bonded carbon under appropriately adjusted conditions.

### EXAMPLES

### Example 1

A discrete track medium was fabricated in the method shown in FIGS. 6A to 6G. Oxygen mixed sputtering of a SiC target was used to fill the recesses between recording tracks. The oxygen mixed sputtering replaces the majority of C in SiC with O. Thus, the deposited nonmagnetic layer is called SiOC. Deposition of an SiOC film with a thickness of 100 nm by RF sputtering under the condition of Ar:O₂=75 sccm:5 sccm and etching-back in thickness of 90 nm, 100 nm and 100 nm were repeated three times to form a nonmagnetic layer. The nonmagnetic layer filled between the recording tracks was observed with sectional TEM. It was confirmed that the nonmagnetic layer includes three sublayers. A DLC protective layer was deposited on the nonmagnetic layer by CVD, and then a lubricant was applied to the DLC protective layer. This medium was assembled in a drive and tested for durability. This test was to measure the time until head crash was caused. A continuous operation for several days to several weeks was attained.

### Comparative Example 1

In fabricating a discrete track medium, oxygen mixed sputtering of a SiC target was used to fill the recesses between recording tracks as in Example 1. However, deposition of an SiOC film with a thickness of 300 nm by RF sputtering under the condition of Ar:O₂=75 sccm:5 sccm and etching-back in thickness of 290 nm were performed only once to form a nonmagnetic layer of a single-layer structure. A DLC protective layer was deposited on the nonmagnetic layer by CVD, and then a lubricant was applied to the DLC protective layer. This medium was assembled in a drive and tested for durability. The time until head crash was caused was measured. As a result, the average operating time was 3.5 hours.

Comparing the results of Example 1 and Comparative Example 1, it was found that the discrete track medium in which the multilayer nonmagnetic layer was filled between the recording tracks brought about stable operation when assembled in the drive. When SiOC is used as a single layer to fill the recesses, it may be cracked or peeled off upon contact with the head due to high hardness thereof. On the other hand, when the nonmagnetic layer used to fill the recesses is made in a multilayer structure, the nonmagnetic layer becomes to have structural softness. Thus, a medium having high resistance to impact could be manufactured.

### Example 2

As in Example 1, a discrete track medium was fabricated in the same method as shown in FIGS. 6A to 6G. As the nonmagnetic layer to fill the recesses between the recording tracks, C, Si, SiO₂, SiₓN_{y}, SiON, SiC, TiOₓ, Al₂O₃, Ru, Ta, or NiTa was used. Deposition of a nonmagnetic material with a thickness of 100 nm and etching-back in thickness of 90 nm, 100 nm and 100 nm were repeated three times to form a nonmagnetic layer. The nonmagnetic layer filled between the recording tracks was observed with sectional TEM. It was confirmed that the nonmagnetic layer includes three sublayers. A DLC protective layer was deposited on the nonmagnetic layer by CVD, and then a lubricant was applied to the DLC protective layer. Each medium thus manufactured was assembled in a drive to measure acoustic emission (AE). As a result, no AE signal was observed in any medium.

### Comparative Example 2

As in Example 2, a discrete track medium was fabricated in the same method as shown in FIGS. 6A to 6G. As the nonmagnetic layer to fill the recesses between the recording tracks, DC-sputtered Cu was used. Deposition of a Cu film with a thickness of 100 nm and etching-back in thickness of 90 nm, 100 nm and 100 nm were repeated three times to form a three-layered nonmagnetic layer. A DLC protective layer was deposited on the nonmagnetic layer by CVD, and then a lubricant was applied to the DLC protective layer. The medium thus manufactured was assembled in a drive to measure acoustic emission (AE). As a result, AE signals were observed, showing that the medium brought about a problem when mounted in the drive.

According to sectional TEM observation, it was found that the surface of the medium after etching back was not flattened, and a number of abnormal projections different from the geometry before filling were formed. It is assumed that flattening did not take place due to occurrence of reflow of metal by the heat generated during filling and etching back.

Comparing the results of Example 2 and Comparative Example 2, it was found that the multilayered nonmagnetic layer can be formed stably by using the materials recited in Example 2.

### Example 3

As in Example 1, a discrete track medium was fabricated in the same method as shown in FIGS. 6A to 6G. Oxygen mixed sputtering of a SiC target was used to fill the recesses between recording tracks. Deposition of an SIOC film with a thickness of 100 nm by RF sputtering under the condition of Ar:O₂=75 sccm:5 sccm and etching-back in thickness of about 100 nm were repeated three, five, eight, or ten times to form a nonmagnetic layer. The nonmagnetic layer filled between the recording tracks was observed with sectional TEM. It was confirmed that the nonmagnetic layer in each medium had a multilayered structure. A DLC protective layer was deposited on the nonmagnetic layer by CVD, and then a lubricant was applied to the DLC protective layer. Each medium was assembled in a drive and tested for durability. A continuous operation for several days to several weeks was attained until head crash was caused in all the drives.

### Comparative Example 3

As in Example 1, a discrete track medium was fabricated in the same method as shown in FIGS. 6A to 6G. Oxygen mixed sputtering of a SiC target was used to fill the recesses between recording tracks. Deposition of an SiOC film with a thickness of 100 nm by RF sputtering under the condition of Ar:O₂=75 sccm:5 sccm and etching-back in thickness of about 100 nm were repeated 11, 13, or times to form a nonmagnetic layer. The nonmagnetic layer filled between the recording tracks was observed with sectional TEM. It was confirmed that the nonmagnetic layer in each medium had a multilayered structure. A DLC protective layer was deposited on the nonmagnetic layer by CVD, and then a lubricant was applied to the DLC protective layer. Each medium was assembled in a drive and tested for durability as in Example 3. A continuous operation until head crash was caused was less than one day in all the drives.

The number of dust particles was counted in the discrete track media of Example 3 and Comparative Example 3. The results are summarized in Table 1. In Comparative Example 3, it is assumed that increase in the process time and thus reduction in the thickness of a sublayer of the nonmagnetic layer is a cause of peeling-off of the film due to stress and generation of dust particles. Hence, it is found that the number of sublayers of the multilayered nonmagnetic layer is preferably 10 or less.

TABLE 1

| | | Number of |
|---|---|---|
| Number of | Durability test | dust particles |
| sublayers | (days) | (/cm²) |
| 3 | 2.3 | 0.1 |
| 5 | 4.5 | 1.3 |
| 8 | 1.9 | 1.5 |
| 10 | 2.2 | 2.3 |
| 11 | 0.6 | 5.6 |
| 13 | 0.3 | 10 |
| 15 | 0.1 or less | 25 |

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A magnetic recording medium comprising:
a soft magnetic underlayer formed on a substrate;
magnetic patterns made of a ferromagnetic material and provided separately on the soft magnetic underlayer; and
a nonmagnetic layer comprising two sublayers or more of a same material and formed on the soft magnetic underlayer between the magnetic patterns.

2. The medium according to claim 1, wherein the nonmagnetic layer comprises two sublayers or more and ten sublayers or less.

3. The medium according to claim 2, wherein the nonmagnetic layer comprises two sublayers or more and eight sublayers or less.

4. The medium according to claim 1, wherein the nonmagnetic layer comprises at least one material selected from the group consisting of C, Si, SiO₂, SiₓN_{y}, SiON, SiC, SiOC, TiOₓ, Al₂O₃, Ru, Ta, and NiTa.

5. A method of manufacturing a magnetic recording medium comprising:
depositing a soft magnetic underlayer on a substrate;
providing magnetic patterns made of a protruded ferromagnetic material separately from each other on the soft magnetic underlayer; and
repeating procedures of depositing a nonmagnetic material on a surface of the magnetic patterns and on a surface of the soft magnetic underlayer and etching-back the nonmagnetic material twice or more.

6. The method according to claim 5, wherein the procedures are repeated twice or more and tenth or less.

7. The method according to claim 6, wherein the procedures are repeated twice or more and eighth or less.

8. The method according to claim 5, wherein the nonmagnetic layer comprising at least one material selected from the group consisting of C, Si, SiO₂, SiₓN_{y}, SiON, SiC, SiOC, TiOₓ, Al₂O₃, Ru, Ta, and NiTa.

9. A method of manufacturing a magnetic recording medium comprising:
depositing a soft magnetic underlayer on a substrate;
depositing a ferromagnetic layer on the soft magnetic underlayer;
applying a resist to the ferromagnetic layer;
arranging a stamper having protruded patterns so as to face the resist;
imprinting the stamper on the resist to transfer the protruded patterns of the stamper to the resist;
removing resist residues remaining at bottoms of recesses of the resist;
etching the ferromagnetic layer using the protruded patterns of the resist as masks to form magnetic patterns separately from each other on the soft magnetic underlayer; and
repeating procedures of depositing a nonmagnetic material on a surface of the magnetic patterns and on a surface of the soft magnetic underlayer and etching-back the nonmagnetic material twice or more.
